(19) United States
(12) Patent Application Publication
(10) Pub. No.: US 2011/0129805 A1
(43) Pub. Date: Jun. 2, 2011

(54) EDUCATIONAL NAPKIN DEVICE

(75) Inventors: Melanie C. Bolt, Port Huron, MI (US); Laura L. Riebandt, Marysville, MI (US)

(73) Assignee: HALISHINE, LLC, Port Huron, MI (US)

(21) Appl. No.: 12/945,944

(22) Filed: Nov. 15, 2010

Related U.S. Application Data
(60) Provisional application No. 61/265,925, filed on Dec. 2, 2009.

(51) Int. Cl. G09B 19/00

(52) U.S. Cl. 434/127

(57) ABSTRACT

A napkin includes an educational napkin design on one or both of the front and back surfaces. The napkin designs encourage learning for users including children through manipulation of food including snack foods. The user's food is placed on the napkin and the user, with or without help from an adult, depending on the user's individual intellectual development, positions the food in response to a posed question or instruction provided with the napkin design.

### CROSS-REFERENCE TO RELATED APPLICATIONS

This application claims the benefit of U.S. Provisional Application No. 61/265,925, filed on Dec. 2, 2009. The entire disclosure of the above application is incorporated herein by reference.

### FIELD

The present disclosure relates to designs applied on napkins to be used as educational tools.

### BACKGROUND

This section provides background information related to the present disclosure which is not necessarily prior art.

Teachers and parents of young children are always looking for new and inventive ways to add learning to the child's day. Many feel the best way for children to learn is by doing. Active involvement while learning makes learning fun and may assist in the retention of information, especially for young children. Learning tools which aid in this process can be helpful in the classroom setting as well as at home or any forms of eatery that cater to children. Teachers, in particular, are having more and more difficulty finding time in a school day to complete all the required learning. Learning that can take place while a child is having a mid-morning or afternoon snack is very time effective and fun for the child.

Typically, paper dinner/snack napkins serve the purpose of a disposable cleaning implement or as a place setting for dry snacks or small meals. Paper napkins may have a picture or design printed on them strictly for aesthetic purposes.

### SUMMARY

This section provides a general summary of the disclosure, and is not a comprehensive disclosure of its full scope or all of its features.

A napkin includes an educational napkin design imprinted on one or both of the front and back surfaces. The napkin designs encourage learning for users such as children through manipulation of food such as snack foods. The user's food is placed on the napkin and the user, with or without help from an adult, depending on the user's individual intellectual development, positions the food in response to a posed question or instruction provided with the napkin design.

The present disclosure provides educational designs on dinner and/or snack napkins that can be used to supplement a learning exercise in a classroom setting when snacks or meals are being served.

The present disclosure also provides paper dinner and/or snack napkins with educational napkin designs so that children may be offered a tool that specifically addresses the process of learning-by-doing through the physical manipulation of food. Parents can also use the educational napkin designs of the paper napkins and/or snack napkins of the present disclosure to encourage their children to try new foods.

The present disclosure also provides restaurants or fast food chains with educational designs on paper dinner and/or snack napkins for their young patrons.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a plan view of a napkin design having color blocks requiring the user to sort;

FIG. 2 is a plan view of a napkin design having lines of various lengths requiring the user to count and measure;

FIG. 3 is a plan view of a napkin design having a geometric design requiring the user to form a shape;

FIG. 4 is a plan view of a napkin design having a measurement grid requiring the user to measure in increments;

FIG. 5 is a plan view of a napkin design requiring the user to form a letter;

FIG. 6 is a plan view of a napkin design having different size geometric shapes requiring the user to count;

FIG. 7 is a plan view of a napkin design having arithmetic equations requiring the user to perform addition;

FIG. 8 is a plan view of a napkin design having arithmetic equations requiring the user to perform subtraction; and

FIG. 9 is a plan view of a napkin design having blank equation forms allowing the user to create individualized equations using addition or subtraction.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

As used herein, the term “and/or” includes any and all combinations of one or more of the associated listed items. Although children are commonly referred to herein as users of the napkin designs, the present disclosure is not limited to any age group of user, as napkin designs of the present disclosure can also be used for entertainment by any age group, to help persons recovering from injuries, or be used by developmentally challenged individuals of any age as well. The term “napkin” as used herein refers generally to paper napkins to provide a base for printing the designs of the present disclosure, however, the present disclosure is not limited to paper napkins or napkins intended for a single use, as cloth napkins or multiple use napkins, plastic or polymeric materials able to receive the designs of the present disclosure as printed, stamped, or embossed designs or by similar application methods, as well as paper towels, paper plates, place mats and the like that are broadly available for use during a meal or snack period are broadly included under the term “napkin” and can also have the designs of the present disclosure printed, stamped, or embossed on or temporarily placed thereon.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

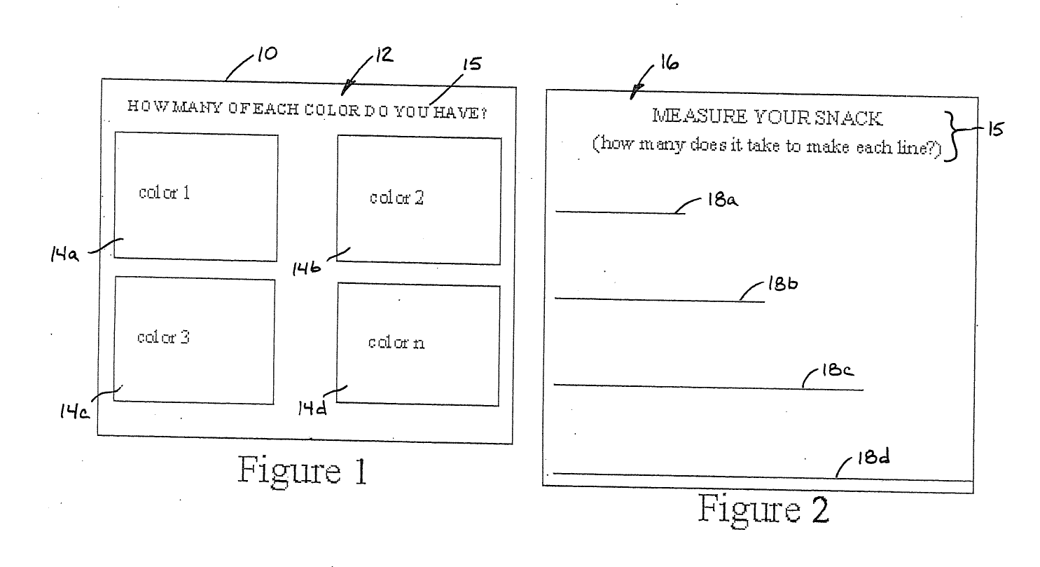

Referring to FIG. 1, a napkin 10 includes a napkin design 12 having a plurality of individual spaces defined as blocks 14a, 14b, 14c, 14(n) each having a different color. A user such as a child can sort a food item such as a snack according to color, and place individual pieces or portions of the food item sorted by color onto the individual blocks 14 according to color. Food items contemplated by the present disclosure can include but are not limited to: 1) snacks such as raisins, nuts, cookies, candies, and the like; and/or 2) meal items such as French fries, beans, peas, individual cereal pieces, noodles and the like. Food items can also include individual foods such as crackers, bread, fruit, and/or the like that can be divided into multiple pieces. Sorting the food item by color teaches a younger child such as a child between the ages of 3 to 6 color recognition and sorting skills. Children older that about 6 years of age can choose to count a quantity of the food items in each group or work on subtraction skills by eating items only of a particular color.

Referring to FIG. 2, a napkin design 16 includes individual spaces defined by lines 18a, 18b, 18c, 18d of varying lengths. The user can place a food item on, above, or below any of the lines 18a, 18b, 18c, 18d to determine its size compared to the individual line or with respect to proximate ones of the lines. The user can visualize how many food items would be required, or position individual ones of the food items (e.g., raisins, crackers, grapes, or the like) required to make each line shown. A quantify of lines used can also be varied to create larger or smaller sizes of napkin designs 16. Napkin design 16 allows the user to work on skills including measuring and counting.

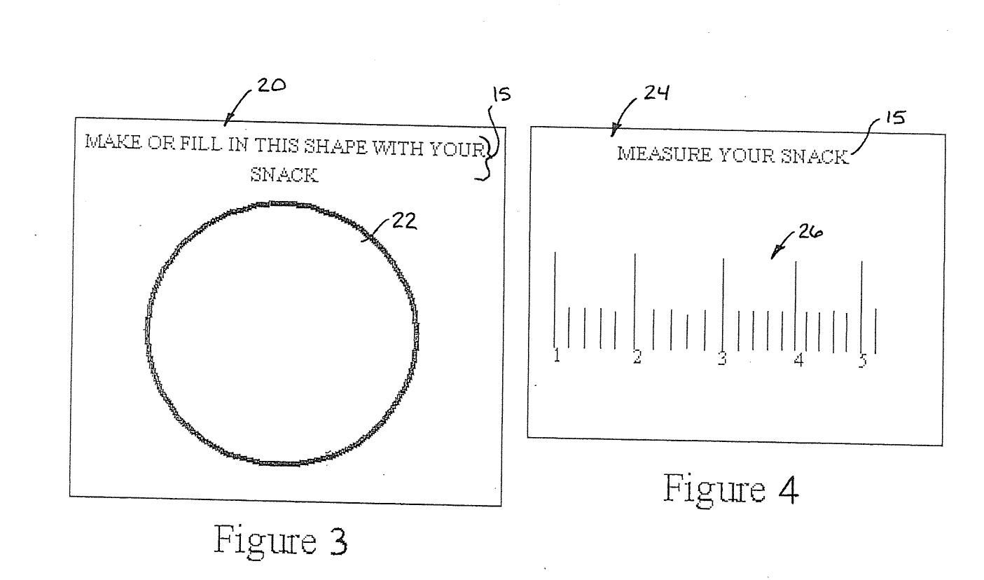

Referring to FIG. 3, a napkin design 20 includes at least one individual space defined by a geometric shape 22. In the example shown a geometric shape of a square is used, although any geometric shape can also be substituted for the square. The user can position sufficient pieces of the food item to either fill-in the shape or create the shape, thereby working on skills of shape recognition and quantity estimations. An alternative method of use can include positioning the food items outside of the geometric shape, or combinations thereof.

Referring to FIG. 4, a napkin design 24 includes an individual space defined by a measurement scale 26 in an exemplary form of a ruler for performing measurements of the food item geometry, such as length, width, diameter, and the like. The user can place the individual food item or portion of the food item on the scale (or be taught how to use the measurement scale) and identify a dimension of the food item or a total length of multiple food items. Increments used can include inches, millimeters, centimeters, and the like, and fractions thereof.

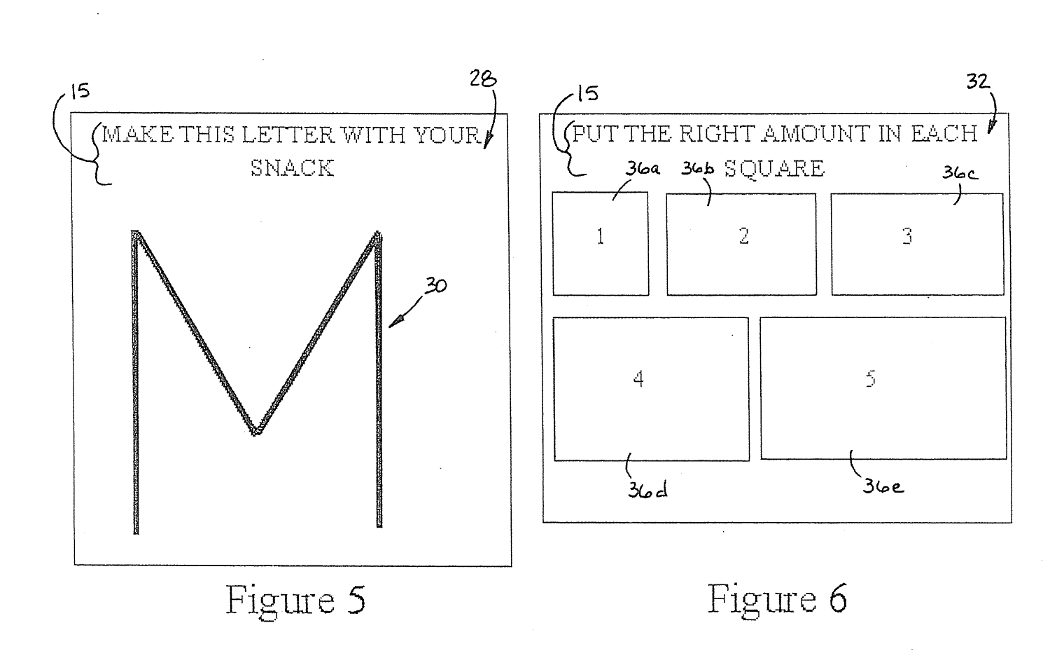

Referring to FIG. 5, a napkin design 28 provides one or more individual spaces defined by letters such as letter 30 of the alphabet. The user can apply one or more pieces of the food item to form the portions such as the legs of the letter(s), for example the upper case letter “M” shown, the portions of the arc used for example in the letter “O”, or to dot a letter such as the letter “i”. Napkin design 28 therefore can be used to help teach letters of the alphabet. If the space envelope of the napkin permits, several and/or all of the letters of the alphabet can be provided on the napkin.

Referring to FIG. 6, a napkin design 32 provides a plurality of individual spaces defined by geometric shapes 34, which in the present embodiment includes five rectangles 36a, 36b, 36c, 36d and 36e, each containing a number one through five. The user can count out their food items and place the correct number of food items in each of the geometric shapes. Napkin design 32 therefore can be used to help teach counting skills.

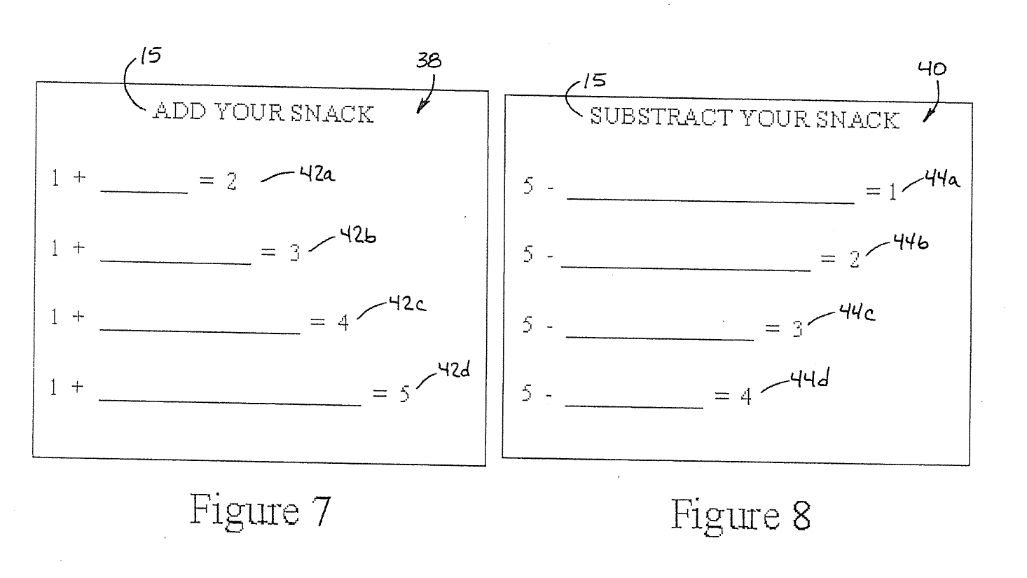

Referring to FIGS. 7 and 8, napkin designs 38, 40 each provide a plurality of individual spaces defined by math equations 42a, 42b, 42c, 42d and 44a, 44b, 44c, 44d. The user can place the correct number of food items in the blank spaces to make the addition or subtraction statements true. Napkin designs 38, 40 therefore can be used to help teach more advanced counting skills.

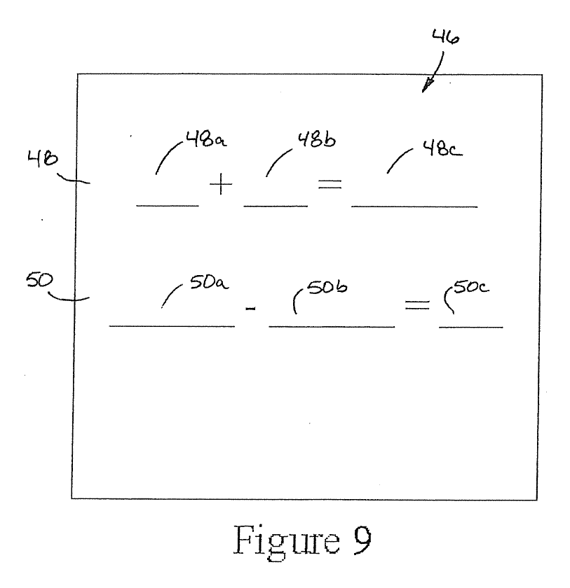

Referring to FIG. 9, a napkin design 46 is similar to napkin designs 38, 40 but includes individual spaces defined by an addition equation 48 having all blank lines 48a, 48b, 48c, and a subtraction equation 50 having all blank lines 50a, 50b and 50c for placement of different food item quantities. Napkin design 46 therefore permits an unlimited number of equations to be created to make the addition or subtraction statements either true or false. Napkin design 46 therefore can be used to help teach more advanced counting skills.

Referring again to FIGS. 1-8, one or more text lines 15 can be included with the napkin designs which provide a unique question to be answered and/or directions for placing individual food items on the individual spaces of the napkin design. The text lines 15 can be in a single or multiple fonts and/or sizes, and can be positioned at any location on the napkin 10. With further reference to FIG. 9, napkin designs such as napkin design 42 can be provided with no text line, therefore providing no specific application for the user, leaving the user to make up an application of the napkin design, or the text line can be positioned on an opposite side of the napkin 10 from the napkin design 42 if the user desires some instruction for its use.

Napkin designs of the present disclosure individually provide a geometric design, pattern, color, symbol, graph, incremental measurement, equation, text line(s) and/or the like, all collectively referred to as individual “patterns”. Each pattern is either permanently or temporarily formed on or adhered to the napkin 10. Although napkin designs of the present disclosure can be used in single-use (throw away) applications, napkin designs of the present disclosure can also be created on multiple use napkins in a format such as a plastic decal or sewn pattern which can be cleaned, washed, or the like with the napkin for multiple uses of the napkin design.

Napkins 10 as referred to herein can be made of paper, cloth, plastic, or any material adapted to receive the napkin designs of the present disclosure. The designs of the present disclosure can be printed from an inked die, stamped, embossed, sewn, applied as a decal, or applied by using any process that temporarily or permanently connects the pattern (napkin design) to the napkin. The present disclosure provides a tool that parents, teachers, caregivers and the like who have contact with children can use to enhance learning during snack or meal times. A single one of the napkin designs described herein can be applied on one or both sides (faces) of a napkin, or different ones of the napkin designs can be provided on opposite sides of a napkin.

Through the use of the present napkin designs, a teacher in a classroom setting having a pre-defined snack or meal break does not have to find extra time in the school day to add the learning exercise provided by the napkin design. If a snack time is offered, this tool can easily be used with no further course input or preparation by the teacher.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An educational device using a napkin, comprising a napkin design applied to at least one side of a napkin, the napkin design provided as a pattern having at least one indicated space where one or more food items are placed based on a direction indicated in a text line provided on the napkin.

2. An educational device using a napkin, comprising a napkin design applied to at least one side of a napkin, the napkin design provided as a pattern having at least one indicated space where one or more food items are placed at the discretion of a user.
